(19) United States
(12) Patent Application Publication
(10) Pub. No.: US 2026/0167417 A1
(43) Pub. Date: Jun. 18, 2026

(54) REFUSE VEHICLE PACKER ACTUATING

(71) Applicant: The Heil Co., Chattanooga, TN (US)

(72) Inventor: Jesus Alejandro de Leon Tello, Fort Payne, AL (US)

(21) Appl. No.: 19/420,325

(22) Filed: Dec. 15, 2025

Related U.S. Application Data
(60) Provisional application No. 63/734,582, filed on Dec. 16, 2024.

(51) Int. Cl. B65F 3/20; B65F 3/02

(52) U.S. Cl. CPC B65F 3/206; B65F 3/02; B65F 2003/0283

(57) ABSTRACT

A refuse collection vehicle includes a vehicle chassis defining a forward and rearward direction of travel. A refuse body on the vehicle chassis includes a storage container, and a packer configured to pack waste within the storage container. The packer includes a prime mover, a packer blade, and a reciprocating linear actuator operably coupled to the prime mover and configured to exert a variable force on the packer blade. The reciprocating linear actuator includes a crank rotatable in response to torque from the prime mover, an arm pivotable in response to rotation of the crank, and a driver structurally connected to the packer blade. The driver is translatable along the forward and rearward directions in response to pivoting of the arm.

### CROSS-REFERENCE TO RELATED APPLICATION

This application claims priority under 35 U.S.C. § 119 to U.S. Application Ser. No. 63/734,582, filed on Dec. 16, 2024, the contents of which is hereby incorporated by reference.

### TECHNICAL FIELD

This disclosure relates to the field of refuse collection vehicles.

### BACKGROUND

Refuse collection vehicles are typically used to pick up quantities of refuse (e.g., garbage, waste, recyclables, etc.) for hauling to a designated area, such as a landfill, transfer station, or material recovery facility. These vehicles hold the refuse in a relatively large storage container supported on the vehicle chassis. Many refuse collection vehicles include an onboard system—colloquially called a “packer”—that moves and compacts the refuse within the storage container. Compacting the refuse increases the volume that the vehicle can hold in the storage container before the vehicle must eject the refuse at the designated area. In many cases, the packer is driven by one or more telescopic hydraulic cylinders.

### SUMMARY

Aspects of this disclosure are directed to refuse collection vehicles.

Some implementations of this disclosure feature a refuse collection vehicle. The refuse collection vehicle includes a vehicle chassis defining a forward and rearward direction of travel. The refuse collection vehicle includes a refuse body on the vehicle chassis. The refuse body includes a storage container. The refuse body includes a packer configured to pack waste within the storage container. The packer includes a prime mover, a packer blade, and a reciprocating linear actuator operably coupled to the prime mover and configured to exert a variable force on the packer blade. The reciprocating linear actuator includes a crank rotatable in response to torque from the prime mover, an arm pivotable in response to rotation of the crank, and a driver structurally connected to the packer blade, the driver translatable along the forward and rearward directions in response to pivoting of the arm.

In some implementations, the crank is a wheel rotatable about a central axis.

In some implementations, the refuse collection vehicle further includes a pin mounted on a face of the wheel at a radial distance from the central axis.

In some implementations, the arm further includes an elongated slot constraining the pin mounted on the face of the wheel.

In some implementations, the slot is a non-linear slot.

In some implementations, the wheel includes a first radius of curvature relative to the central axis, and the slot includes a second radius of curvature relative to the central axis different than the first radius of curvature.

In some implementations, the refuse collection vehicle further includes a structural link coupled between the arm and the driver.

In some implementations, the refuse collection vehicle further includes a channel extending across at least a portion of the length of the storage container, wherein the channel constrains movement of the driver to the forward and rearward directions.

In some implementations, the reciprocating linear actuator provides a working stroke and a return stroke.

In some implementations, a work output during the working stroke is greater than a work output during the return stroke.

In some implementations, a velocity of the driver during the return stroke is greater than a velocity of the driver during the working stroke.

In some implementations, the prime mover is at least one of an electric motor or a hydraulic motor.

In some implementations, the prime mover is coupled to the crank via a torque transfer mechanism.

In some implementations, the torque transfer mechanism is at least one of a chain and belt drive, or a gear drive.

In some implementations, the reciprocating linear actuator is a first reciprocating linear actuator, further including a second reciprocation linear actuator positioned opposite the first reciprocating linear actuator within the storage container.

In some implementations, the prime mover operates the first reciprocating linear actuator and the second reciprocation linear actuator.

Some implementations of this disclosure feature a packer configured to pack waste within a storage container. The packer includes a prime mover, a packer blade, and a reciprocating linear actuator operably coupled to the prime mover and configured to exert a variable force on the packer blade. The reciprocating linear actuator includes a crank rotatable in response to torque from the prime mover, an arm pivotable in response to rotation of the crank, and a driver structurally connected to the packer blade, the driver translatable along forward and rearward directions in response to pivoting of the crank arm.

In some implementations, the crank is a wheel rotatable about a central axis.

In some implementations, the packer further includes a pin mounted on a face of the wheel at a radial distance from the central axis.

In some implementations, the arm further includes an elongated slot constraining the pin mounted on the face of the wheel.

Refuse collection vehicles often include packing mechanisms for compacting and ejecting refuse material. The forces required to effectively pack and eject the large quantities of refuse stored in a refuse collection vehicle are substantial. To meet the demands of this application, packer blades (or “rams”) used to pack and eject the material are often driven using powerful multi-stage telescopic hydraulic cylinders. Although these hydraulic cylinders are well-suited to supply the forces needed to achieve packing and ejecting, they often induce high maintenance costs. The potential for contamination of the hydraulic fluid, for example, results in frequent maintenance intervals, vehicle down-time, and sometimes costly repairs. Accordingly, by providing an alternative actuator solution for packing and ejecting, the embodiments described in this specification can be implemented to realize one or more material advantages, including increased reliability and operational efficiency.

Various additional features, objects, and advantages will be apparent from the following description and drawings, and from the claims.

### DESCRIPTION OF DRAWINGS

FIG. 1 is a side view of a front-loading refuse collection vehicle including a refuse packer within the scope of the present disclosure.

FIG. 2 is a top perspective view of a front-loading refuse collection vehicle illustrating a refuse packer driven by a reciprocating linear actuator.

FIG. 3 is a rear perspective view illustrating the refuse packer of the refuse collection vehicle of FIG. 2.

FIG. 4 illustrates the reciprocating linear actuator of the refuse collection vehicle of FIG. 2.

FIGS. 5A-5C are sequential diagrams illustrating a reciprocating linear actuator driving a refuse packer blade during a packing cycle.

FIGS. 6A-6F are sequential diagrams illustrating a reciprocating linear actuator driving a refuse packer blade during an ejecting cycle.

### DETAILED DESCRIPTION

Implementations of the present disclosure are directed to systems, devices, and methods for collecting, packing, transporting, and disposing of refuse. Some implementations include a reciprocating packing device. The reciprocating packing device includes a packing blade that is operated to move back and forth to pack the waste. The packing blade can be driven by an actuator. The waste can be further compacted or ejected from the container by way of an ejecting cycle utilizing the actuator and packing blade.

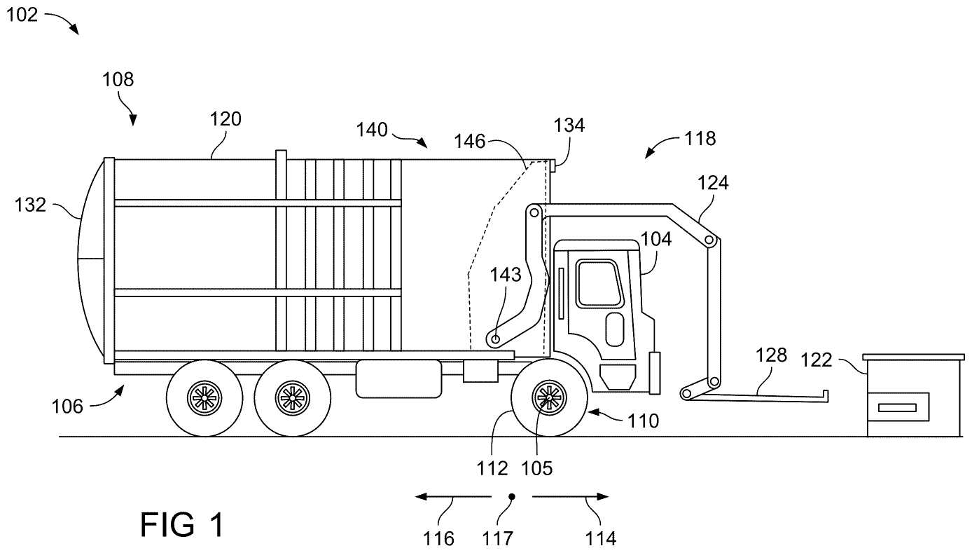

FIG. 1 depicts a vehicle 102 for collecting and transporting refuse (e.g., garbage). Refuse collection vehicles such as vehicle 102 are often described colloquially as garbage collection vehicles or just “garbage trucks.”

Refuse collection vehicle 102 includes a cab 104, a chassis 106, and a refuse collecting body 108. Cab 104 includes a compartment for a driver of vehicle 102. The compartment is equipped with controls that enable the driver to operate various elements of chassis 106 and body 108. Chassis 106 includes a power train 110 (e.g., a diesel, CNG, or electric power train). Power train 110, which includes a prime mover and a drivetrain, converts and transfers motive power to the wheels 112 that move vehicle 102 on a road surface along a forward direction of travel 114 and a rearward direction of travel 116. For ease of discussion, we reference the direction across vehicle 102 and orthogonal to the forward/rearward directions as a transverse direction 117.

Vehicle 102 is a front-loading refuse collecting vehicle. Accordingly, refuse collecting body 108, which is coupled to chassis 106, includes a front lift 118 and a storage container 120. Front lift 118 includes an arm assembly 124 driven by an arm actuator (not shown) and a fork assembly 128 driven by a fork actuator (not shown). Arm assembly 124 rotates pivotally along a pivot axis 143 (which is parallel to transverse direction 117) relative to chassis 106 and storage container 120.

During use, the arm actuator drives arm assembly 124 to rotate between a lowered position and a raised (dump) position as part of a manual or automated dump cycle. In one exemplary dump cycle, front lift 118, via fork assembly 128, engages a waste container 122 located on the ground in front of the cab 104. Next, front lift 118 lifts waste container 122 above cab 104 by driving arm assembly 124 to rotate via the arm actuator. Front lift 118 then dumps the contents of waste container 122 into storage container 120 by rotating fork assembly 128 with the fork actuator.

Refuse collecting body 108 further includes a pivoting tailgate 132 for controlling access to an opening of storage container 120 and a packer 140 for packing waste within storage container 120 and expelling waste from storage container 120 when tailgate 132 is pivoted upward to an open position.

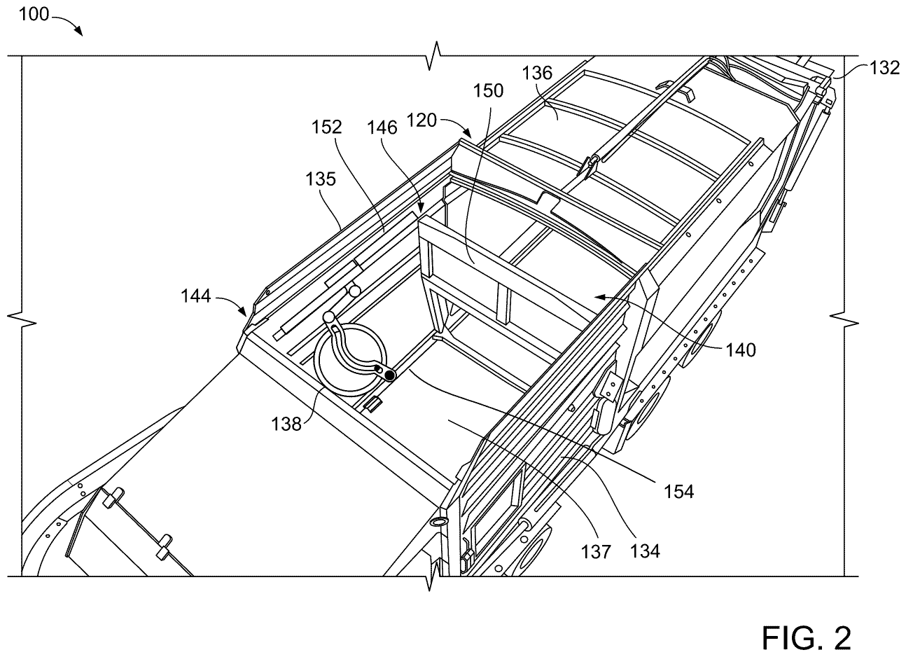

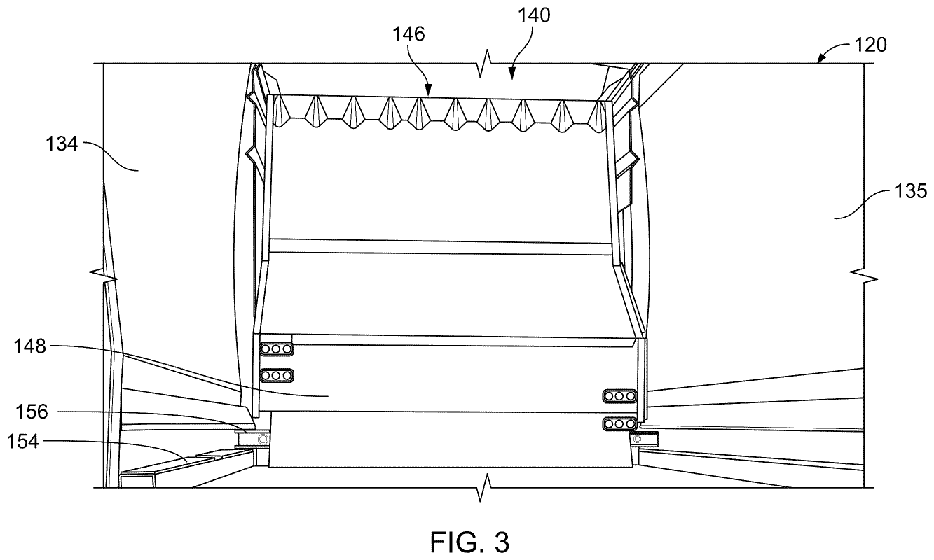

FIGS. 2-3 illustrate packer 140 in a partially extended condition within storage container 120, such as during a packing or ejecting cycle. As shown, storage container 120 provides an interior volume between a pair of side walls 134, 135, a top surface (e.g., roof) 136, a floor 137 (inner bottom surface), a front wall 138, and tailgate 132. The components of packer 140 reside in the interior volume of storage container 120. In this example, packer 140 includes a prime mover (not shown), an actuator 144, and a packer blade 146 (sometimes called a “ram”).

Packer blade 146 extends across substantially the entire width and height of the interior volume of storage container 120. Packer blade 146 includes a refuse-contacting face 148 (see FIG. 3) and a non-refuse contacting face 150 (see FIG. 2). The refuse-contacting face 148 contacts and compacts waste in storage container 120 when packer blade 146 is translated rearward by prime mover 142 and actuator 144.

Translating movement of packer blade 146 is guided by a track assembly built into storage container 120. In this example, the track assembly includes an upper track 152 and a lower track 154, each of the tracks extending lengthwise along storage container 120. Each of the upper and lower tracks 152, 154 includes two parallel channels, one integrated in each of the two opposing side walls 134, 135 of storage container 120. Lower track 154 engages a wear bar 156 attached to packer blade 146. As discussed further below, upper track 152 engages and constrains a portion of the packer's actuator 144.

Packer blade 146 moves along the track assembly between a retracted position and an extended position within storage container 120. When retracted, packer blade 146 is positioned toward the forward end of storage container 120, making sufficient space to receive the contents of waste container 122 (see FIG. 1). When extended, packer blade 146 is positioned toward the rearward end of storage container 120, reducing the space within the storage container 120 to pack and/or eject contents received from waste container 122 (see FIGS. 2-3).

Once the contents of the waste container 122 are received in the storage container 120, the packer 140 can operate a packing cycle or an ejecting cycle. During an example packing cycle, the prime mover drives the actuator 144 which operates to move the packer blade 146 rearwardly along a portion of the length of the storage container 120 while the tailgate 132 is closed. The packing cycle enables the packer blade 146 to compact the existing waste contents within the storage container 120 to create more space to receive additional waste contents. Once the packing cycle has packed the contents in the storage container 120, the actuator 144 operates to move the packer blade 146 to return via forward movement back to the retracted position, completing the packing cycle. During an example ejecting cycle, the tailgate 132 is opened and the prime mover drives the actuator 144 which operates the packer blade 146 to move rearwardly along the full length of the storage container 120 to push the contents out of the now-open end of waste container 122. The fully-extended packer blade 146 is then operated by the actuator 144 to move forward, back to the retracted position, completing the ejecting cycle.

The above-described packing and ejecting cycle movements of the packer blade 146 are powered by the prime mover and the actuator 144. The prime mover and the actuator 144 operate to drive the packer blade 146 rearward and forward within the storage container 120. As described further below, the actuator 144 is a reciprocating linear actuator operably coupled to the prime mover and configured to exert a variable force on the packer blade 146.

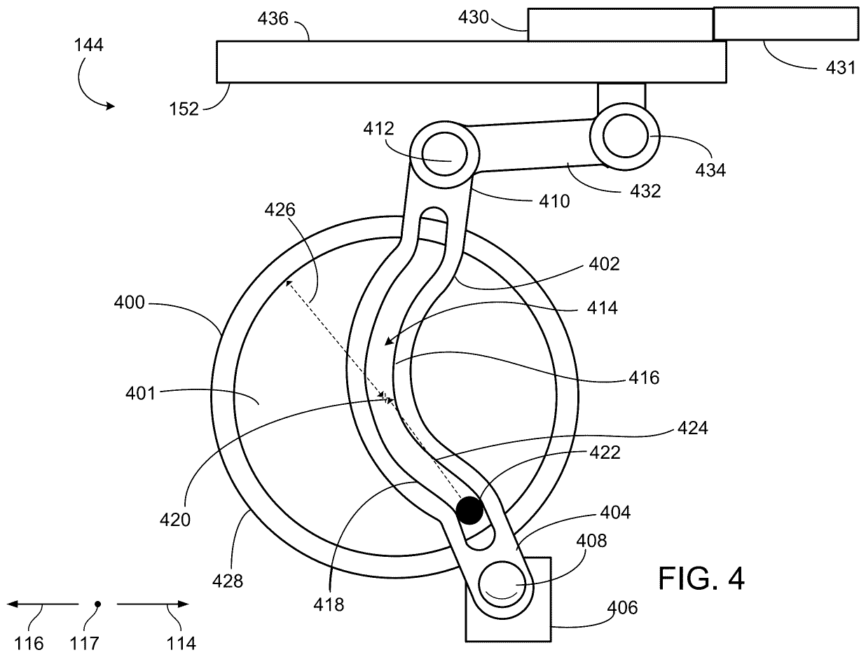

Turning to FIG. 4, the actuator 144 includes a crank 400, a pivoting arm 402, a structural link 432, a driver 430, and a rod 431. As discussed further below, rotation of the crank 400 drives pivotal movement of the arm 402, which transfers force through the structural link 432 to induce linear movement of driver 430, which imparts a force on the rod 431, thereby moving the packing blade 146.

The crank 400 includes a wheel 401 and a pin 422. In this example, the wheel 401 takes the form of a solid, one-piece circular plate having a central axis 420 and a radius of curvature 426. The pin 422 is mounted on a flat face of the wheel 401 at a radial distance 424 from the central axis 420. The radial distance 424 affects the magnitude and angular direction of the torque applied by the crank 400 to the arm 402 during operation of the actuator 144. In some implementations, a ratio of the wheel's radius of curvature 426 over the pin's radial distance 424 is between about 1-5, such as between about 1-3, between about 1-2, and/or between about 1-1.5. The term “about” in this disclosure, when used to describe a numerical range or value, references a margin within ±5% of the stated value or range.

The crank 400 is rotatable about the central axis 420 in response to torque from the prime mover. In some implementations, the prime mover is at least one of an electric motor or a hydraulic motor. In some implementations, the prime mover is coupled to the crank 400 via a torque transfer mechanism. The torque transfer mechanism may include at least one of a chain drive, a belt drive, or a gear set.

As discussed, the actuator 144 includes an arm 402 driven by the rotating crank 400. In this example, the arm 402 is constrained to move according to a single degree of freedom. Specifically, the arm 402 is pivotable in response to rotation of the crank 400.

As shown, the arm 402 includes a first end 404, a second end 410, and an elongated slot 414 between the two ends. The first end 404 is secured in place relative to the waste container 120 by a fixed structure 406. The connection to the fixed structure 406 is such that the first end 404 is permitted to rotate about a first axis 408 while being constrained against all other linear or rotating movements. The second end 410 of the arm 402 is attached to the structural link 432 by a rotary joint that permits pivotal movement between the arm 402 and the structural link 432 about a second axis 412 while constraining all other relative linear or rotating movements between them. The elongated slot 414 is formed between two spaced-apart lateral sides of the arm 402—a first side 416 and a second side 418. The first side 416 and the second side 418 are spaced apart to create an opening for coupling with the crank 400. As shown, the elongated slot 414 is curved and arcuate along its length, defining a radius of curvature 428.

The width of the elongated slot 414 is sized to receive the pin 422 of the crank 400. The pin 422 is free to move within the elongated slot 414 and engages (e.g., abuts and presses against) either the first side 416 or the second side 418 of the arm 402 to apply a force during operation. As discussed further below, when the actuator 144 maneuvers the packer blade 146 in a forward direction, the pin 422 engages the second side 418, and when the actuator 144 maneuvers the packer blade 146 in a rearward direction, the pin 422 engages the first side 416. As such, the pin 422 is constrained within the slot 414 and can engage the first side 416 and the second side 418 to maneuver the arm 402.

As noted above, the pin's radial distance 424 impacts the magnitude and angular direction of the torque applied by the crank 400 to the arm 402 during operation of the actuator 144. In some implementations, a ratio of the slot's radius of curvature 428 over the pin's radial distance 424 is between about 0.1-1, such as between about 0.3-1, between about 0.5-1, and/or between about 0.8-1. The term “about” in this disclosure, when used to describe a numerical range or value, references a margin within ±5% of the stated value or range.

The driver 430 is also coupled to the structural link 432 by a rotary joint. The rotary joint permits pivotal movement of the structural link 432 relative to the driver 430 about a third axis 434. The driver 430 is translatable along the forward and rearward directions 114, 116 in response to force transferred from the pivoting arm 402 through the structural link 432. The crank 400 rotates about the central axis 420, thereby maneuvering the pin 422 to engage the arm 402. The pivoting operation of the arm 402 manipulates the driver 430 along the forward and rearward directions 114, 116.

The upper track 152 engages and constrains the driver 430. In particular, the driver 430 is positioned within a channel 436 extending across at least a portion of the length of the storage container 120 and integrated in each of the side walls 134, 135 of storage container 120. The channel 436 constrains movement of the driver 430 to the forward and rearward directions.

The driver 430 is coupled to the rod 431, and the rod 431 is coupled to the packer blade 146. The rod 431, and thus the packer blade 146, is translatable along the forward and rearward directions 114, 116 in response to force transferred from the driver 430. The crank 400 rotates about the central axis 420, thereby maneuvering the pin 422 to engage the arm 402. The operation of the arm 402 manipulates the driver 430 and imparts a force on the packer blade 146 via the rod 431 to move the packer blade 146 along the forward and rearward directions 114, 116.

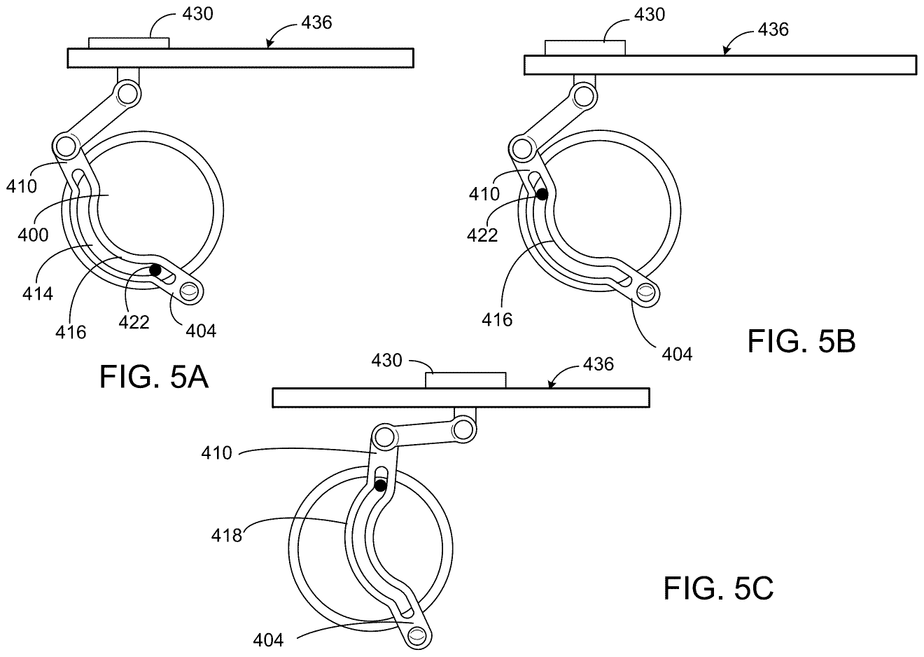

Turning to FIGS. 5A-5C, sequential diagrams are provided illustrating a reciprocating linear actuator driving a refuse packer blade during a packing cycle. FIG. 5A illustrates a first stage of the packing cycle, where the pin 422 is positioned within the slot 414 near the first end 404 of the arm 402 and begins to move in a clockwise direction as the wheel 401 rotates. In FIG. 5B, the pin 422 has maneuvered along the length of the slot 414 to reach the second end 410 of the arm 402 to begin operating the driver 430 along the channel 436. Here, the pin 422 applies a force to the first side 416 of the arm 402, and the resulting torque causes the arm 402 to pivot. Pivotal movement of the arm 402 transfers a force to the driver 430 via the structural link 432. The actuator 144 operates in this way until the driver 430, which is attached to the packer blade 146, reaches the position illustrated in FIG. 5C. In FIG. 5C, the driver 430 has reached a halfway point along the channel 436, meaning the packer blade 146 has extended partially across the length of the storage container 120, compacting the waste held therein. The driver 430 can be operated to extend slightly past the halfway point of the channel 436 and may be moved slightly backward and moved forward again simulating a packing cycle. Alternatively, the driver 430 can apply constant pressure for a period of time to ensure tight packing of the contents in the storage container 120. Once the packing cycle is complete, the pin 422 is operated via the wheel 401 in a counterclockwise manner and applies a force to the second side 418 of the arm 402, operating the driver 430 to return to the position illustrated in FIG. 5A.

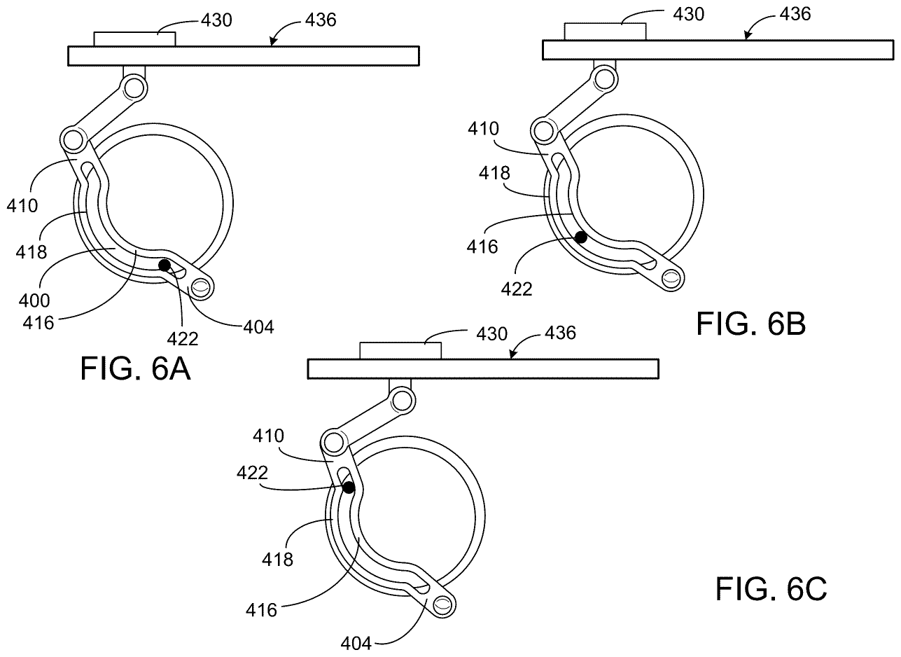

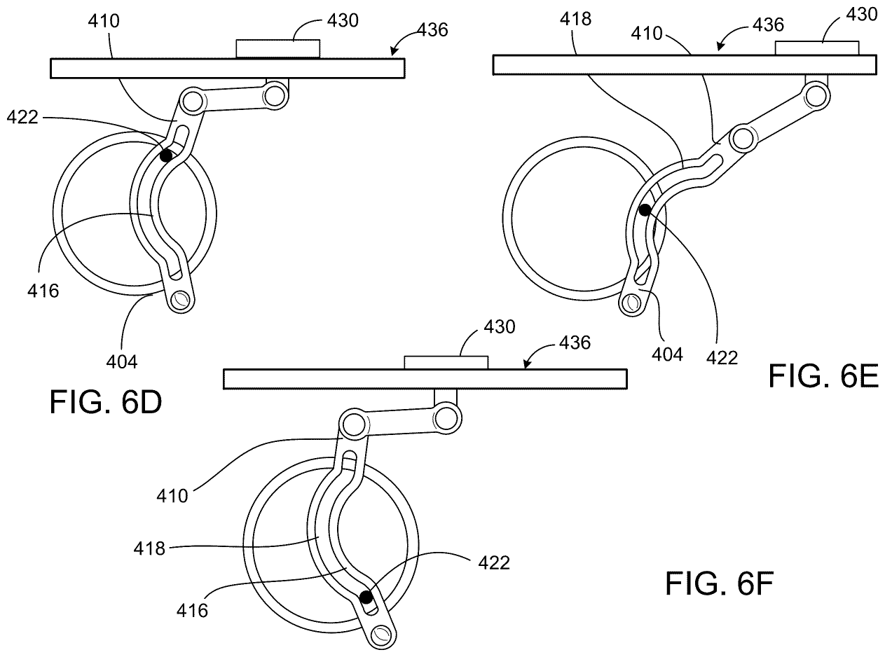

Turning to FIGS. 6A-6F, sequential diagrams are provided illustrating a reciprocating linear actuator driving a refuse packer blade during an ejecting cycle. FIG. 6A illustrates a first stage of the ejecting cycle, where the pin 422 is positioned within the slot 414 near the first end 404 of the arm 402 and begins to move in a clockwise direction as the wheel 401 rotates. In FIG. 6B, the pin 422 is moving along the length of the slot 414 in the clockwise direction towards the second end 410 of the arm 402 as the wheel 401 rotates. In FIG. 6C, the pin 422 has maneuvered along the length of the slot 414 to reach the second end 410 of the arm 402 to begin operating the driver 430 along the channel 436. Here, the pin 422 applies a force to the first side 416 of the arm 402, and the resulting torque causes the arm 402 to pivot. Pivotal movement of the arm 402 transfers a force to the driver 430 via the structural link 432. The actuator 144 operates in this way until the driver 430, which is attached to the packer blade 146 via the rod 431, reaches the position illustrated in FIG. 6D. FIG. 6D illustrates the driver 430 has reached a position beyond the hallway point along the channel 436, meaning the packer blade 146 has extended partially across the length of the storage container 120. Here, the pin 422 engages the first side 416 of the arm 402 and operates the driver 430 beyond the halfway point of the channel 436 (e.g., beyond the length of the packing cycle) to continue to operate the packer blade 146 within the storage container 120. The pin 422 continues to engage the first side 416 of the slot 414 to operate the driver 430 until it reaches the position illustrated in FIG. 6E. In FIG. 6E, the driver 430 has reached the end of the channel 436, meaning the packer blade 146 has reached the end of the storage container 120 near the tailgate 132 and is in an extended position and the contents of the storage container 120 have been ejected. In FIG. 6E, the crank 400 continues to operate in a clockwise manner after the packer blade 146 has reached the end of the storage container 120 and the pin 422 engages the second side 418 of the arm 402 in the slot 414, which operates the driver 430 back along the length of the channel 436 to return the driver 430 to the starting position illustrated in FIG. 6A, meaning the packer blade 146 is operated in a forward direction to a retracted position. FIG. 6F illustrates the pin 422 now having reached the first end 404 again and it will continue to rotate until the driver 430 has reached the starting position illustrated in FIG. 6A, thereby completing the ejecting cycle and returning the packer blade 146 to the retracted position.

The reciprocating linear actuator 144 is designed such that a complete revolution of the wheel 401 causes the driver 430 to execute a working stroke and a return stroke of equal length. The working stroke comprises rearward movement that causes the packer blade 146 to eject contents from the storage container 120, while the return stroke comprises forward movement that returns the packer blade 146 to its starting position (e.g., the retracted position). The actuator 144 is characterized by a greater work output during the working stroke compared to the return stroke, though the velocity during the return stroke exceeds that of the working stroke. These operating characteristics are particularly advantageous for the packer blade 146 during ejection cycles, as more work is required to push out the refuse during the working stroke than to return the packer blade 146 to the retracted position during the return stroke.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

A number of embodiments have been described. Nevertheless, it will be understood that various modifications may be made without departing from the spirit and scope of the disclosure. Accordingly, other embodiments are within the scope of the following claim(s).

For example, although the cab of the refuse vehicle is described above as featuring a compartment for a human driver, in some embodiments the refuse vehicle can be operated autonomously or semi-autonomously.

As another example, although the front lift of the refuse collecting body is described above as including a fork assembly driven by a fork actuator, in some embodiments the body is equipped with a forkless mechanism for coupling the front arm assembly to a waste container, such as a customer-controlled commercial or residential container or an intermediate carry can (e.g., a Curotto-Can™).

As yet another example, the packing cycle can occur automatically after a lift. For example, after the contents are placed in the storage container, the packing cycle can start automatically.

As yet another example, the packing cycle can occur in response to a user command or a command from a remote computer. For example, an individual in a cab of the vehicle can initiate a command to start the packing cycle.

As yet another example, the packing cycle may include multiple rearward/forward movements (e.g., two or three). For example, the driver can move rearward/forward multiple times during a packing cycle to ensure a proper pack of the contents in the storage container.

As yet another example, the actuator can be a non-linear actuator that is operably coupled to the prime mover and configured to exert a variable force on the packer blade 146.

As yet another example, the pin can be a movable pin. For example, the pin can be located in one position during the packing cycle and the pin can be located in another position during the ejecting cycle. As one example, the pin could be positioned within a slot on the face of the wheel that varies the radial distance of the pin as the wheel rotates.

As yet another example, the actuator is a first actuator positioned adjacent the side wall, and the storage container can include a second actuator positioned adjacent the side wall. This ensures that the packer blade can be operated if one of the actuators fails to let the driver complete the route (e.g., keeps the vehicle in service and avoids downtime).

As yet another example, the pin can be constrained by any other structure that permits the same kind of movement (i.e., constrained movement along the length of the arm) as with the slot discussed above. For example, the slot can be rectangular in shape.

As yet another example, the rod can be any shape. That is the cross-section of the rod can be circular, triangular, rectangular, etc.

As yet another example, the prime mover can be an electric or hydraulic motor attached to a gearbox with a sprocket as an output. The prime mover and gearbox can be installed on a lower corner of the front wall adjacent the packer. The gearbox transfers torque to the prime mover through the sprocket.

What is claimed is:

1. A refuse collection vehicle, comprising:
a vehicle chassis defining a forward and rearward direction of travel; and
a refuse body on the vehicle chassis, the refuse body comprising:
a storage container;
a packer configured to pack waste within the storage container, the packer comprising: a prime mover, a packer blade, and a reciprocating linear actuator operably coupled to the prime mover and configured to exert a variable force on the packer blade, the reciprocating linear actuator comprising:
a crank rotatable in response to torque from the prime mover;
an arm pivotable in response to rotation of the crank; and
a driver structurally connected to the packer blade, the driver translatable along the forward and rearward directions in response to pivoting of the arm.

2. The refuse collection vehicle of claim 1, wherein the crank is a wheel rotatable about a central axis.

3. The refuse collection vehicle of claim 2, further comprising a pin mounted on a face of the wheel at a radial distance from the central axis.

4. The refuse collection vehicle of claim 3, wherein the arm further comprises an elongated slot constraining the pin mounted on the face of the wheel.

5. The refuse collection vehicle of claim 4, wherein the slot is a non-linear slot.

6. The refuse collection vehicle of claim 5, wherein the wheel comprises a first radius of curvature relative to the central axis, and the slot comprises a second radius of curvature relative to the central axis different than the first radius of curvature.

7. The refuse collection vehicle of claim 1, further comprising a structural link coupled between the arm and the driver.

8. The refuse collection vehicle of claim 1, further comprising a channel extending across at least a portion of the length of the storage container, wherein the channel constrains movement of the driver to the forward and rearward directions.

9. The refuse collection vehicle of claim 1, wherein the reciprocating linear actuator provides a working stroke and a return stroke.

10. The refuse collection vehicle of claim 9, wherein a work output during the working stroke is greater than a work output during the return stroke.

11. The refuse collection vehicle of claim 10, wherein a velocity of the driver during the return stroke is greater than a velocity of the driver during the working stroke.

12. The refuse collection vehicle of claim 1, wherein the prime mover is at least one of an electric motor or a hydraulic motor.

13. The refuse collection vehicle of claim 12, wherein the prime mover is coupled to the crank via a torque transfer mechanism.

14. The refuse collection vehicle of claim 13, wherein the torque transfer mechanism is at least one of a chain and belt drive, or a gear drive.

15. The refuse collection vehicle of claim 1, wherein the reciprocating linear actuator is a first reciprocating linear actuator, further comprising a second reciprocation linear actuator positioned opposite the first reciprocating linear actuator within the storage container.

16. The refuse collection vehicle of claim 15, wherein the prime mover operates the first reciprocating linear actuator and the second reciprocation linear actuator.

17. A packer configured to pack waste within a storage container, comprising:
a prime mover;
a packer blade; and
a reciprocating linear actuator operably coupled to the prime mover and configured to exert a variable force on the packer blade, the reciprocating linear actuator comprising:
a crank rotatable in response to torque from the prime mover;
an arm pivotable in response to rotation of the crank; and
a driver structurally connected to the packer blade, the driver translatable along forward and rearward directions in response to pivoting of the crank arm.

18. The packer of claim 17, wherein the crank is a wheel rotatable about a central axis.

19. The packer of claim 18, further comprising a pin mounted on a face of the wheel at a radial distance from the central axis.

20. The packer of claim 19, wherein the arm further comprises an elongated slot constraining the pin mounted on the face of the wheel.
